(19) United States
(12) Patent Application Publication
(10) Pub. No.: US 2024/0266582 A1
(43) Pub. Date: Aug. 8, 2024

(54) Electrode Assembly Manufacturing Process

(71) Applicant: LG Energy Solution, Ltd., Seoul (KR)

(72) Inventors: Jea Bong Jung, Daejeon (KR); Chang Bum Ahn, Daejeon (KR); Sangjin Seo, Daejeon (KR); Dongguk Sim, Daejeon (KR); Yeongcheol Jang, Daejeon (KR)

(73) Assignee: LG Energy Solution, Ltd., Seoul (KR)

(21) Appl. No.: 18/273,367

(22) PCT Filed: Jun. 17, 2022
(86) PCT No.: PCT/KR2022/008600

§ 371 Date: Jul. 20, 2023

(30) Foreign Application Priority Data
Jun. 22, 2021 (KR) 10-2021-0080730

(51) Int. Cl. H01M 10/04; H01M 50/466

(52) U.S. Cl. CPC H01M 10/0418; H01M 10/0468; H01M 50/466

(57) ABSTRACT

Provided is an electrode assembly manufacturing process comprising the following steps. First, wrapping a second separator around a laminate structure having alternating layers of positive electrodes, first separators, and negative electrodes. Second, simultaneously pressing the upper end and the lower end of the laminate structure including the second separator-3-2 to strengthen the adhesive strength between each layer of the laminate structure. Third, bonding the excess portions of the second separator-3-2 surrounding the structure, thereby adjusting to meet the standard requirements of the laminate structure. And fourth, bonding each of the bonded portions of the second separator to a respective adjacent portion of the second separator in the lateral dimension. The electrode assembly manufacturing process minimizes damage to the initial structure and allows the wrapping to suit the size of the structure, thereby increasing the utilization value of the electrode assembly.

### CROSS-REFERENCE TO RELATED APPLICATIONS

This application is a national phase entry under 35 U.S.C. § 371 of International Application No. PCT/KR2022/008600 filed on Jun. 17, 2022, which claims the benefit of priority based on Korean Patent Application No. 10-2021-0080730, filed on Jun. 22, 2021, all contents of which are incorporated herein by reference.

### TECHNICAL FIELD

The present invention relates to an electrode assembly manufacturing process.

### BACKGROUND ART

The secondary battery is rechargeable, unlike primary batteries, and due to the possibility of the small size and high capacity, has been widely researched and developed in recent years. As technology development and demand for mobile devices increase, the demand for secondary batteries as an energy source is rapidly increasing.

The secondary battery is composed of an electrode assembly built into a battery case (pouch, can, etc.). The electrode assembly mounted inside the battery case has a stacked structure of positive electrode/separator/negative electrode, thereby allowing repeated charging and discharging.

Conventionally, the electrode assembly was manufactured by lamination & stacking process among electrode assemblies, and specifically, a plurality of mono cells formed by stacking a positive electrode, a separator, a negative electrode, and a separator are stacked, and then the stacked structure is fixed with a tape. In the lamination & stacking method, a positive electrode, a separator, a negative electrode, and a separator are continuously unwound and supplied in a rolled-up state, and then in the separator, the positive electrode and the negative electrode are cut to a certain size and moved, and passed through the laminating device. At this time, the positive electrode and the negative electrode are in a state in which a positive electrode active material and a negative electrode active material are applied on both surfaces of a positive electrode current collector and a negative electrode current collector, respectively. While passing through the laminating device, adhesion is made between each of the positive electrode, the separator, and the negative electrode (between neighboring negative and negative electrodes) by heat and pressure, and the adjacent positive electrode and the positive electrode in the bonded state are cut, and thus one mono cell formed by stacking in the order of the positive electrode, the separator, the negative electrode, and the separator from the top is continuously manufactured. The mono cell is stacked by a predetermined number, and thus is manufactured as an electrode assembly, and if the lamination is complete, each tip of the tape is attached to the mono cell of the uppermost layer and the mono cell of the lowermost layer to be fixed. However, in the fixing method of mono cells using such a tape, the tips of the tape additionally protrude from the top and bottom layers, causing a difference in thickness. In addition, if the tape is attached, there may be a problem that a portion of the edge of the negative electrode (relatively cut larger than the positive electrode for stability) is folded. As such, the thickness difference and the folding of the negative electrode increase the internal resistance, and have the potential to accelerate the degradation of the electrode.

Therefore, the inventors of the present invention have completed the present invention by studying an electrode assembly manufacturing process that can solve the above-mentioned problems.

### PRIOR ART DOCUMENT

### Patent Document

(Patent Document 1) Korean Patent No. 10-1373218

### DISCLOSURE

### Technical Problem

In order to solve the above problems, the present disclosure is intended to provide an electrode assembly manufacturing process by introducing a separator whose length is extended in the left and right directions into one or more of the upper and lower ends of a structure formed by repeatedly stacking positive electrodes, separators and negative electrodes to wrap the structure.

### Technical Solution

According to the first aspect of the present disclosure,
the present disclosure provides an electrode assembly manufacturing process comprising the steps of (1) introducing a second separator 32, whose length is extended in the left and right directions, into a structure formed by repeatedly stacking the positive electrodes 10, the first separators 31 and the negative electrodes 20 to wrap the structure, (2) simultaneously pressing the upper end and the lower end of the structure comprising the introduced second separator 32 to strengthen the adhesive strength between the separator and the electrode, (3) bonding the left and right excess portions of the second separator 32 surrounding the structure up and down, thereby adjusting to meet the standard requirements of the structure; and (4) fixing the bonded second separator 32 by bonding left and right.

In one embodiment of the present disclosure, in step (1), the second separator 32, whose length is extended in the left and right directions, is introduced into at least one of the upper end and the lower end of the structure.

In one embodiment of the present disclosure, the first separator 31 constituting the structure is in contact with one of the neighboring separators by folding the portions protruding from the positive electrode 10 and the negative electrode 20 to the left and right.

In one embodiment of the present disclosure, the length of the second separator 32 is 1.5 to 2.5 times longer than the length in the circumferential direction of the laminate structure to be wrapped.

In one embodiment of the present disclosure, when wrapping the structure with the second separator 32 introduced in step (1), the second separator 32 is adsorbed in at least one of the left and right directions of the structure to secure a space for the excess portion on the side of the structure.

In one embodiment of the present disclosure, when wrapping the structure with the second separator 32 introduced in step (1), the left and right tips of the second separator 32 are positioned so as to be in contact with the upper end or lower end of the structure.

In one embodiment of the present disclosure, when pressing the upper end and lower end of the structure in step (2), the part where the left and right tips of the second separator (32) are in contact with the upper end or lower end of the structure is bonded with the upper end or lower end of the structure in the outside direction from the center of the structure using a roller.

In one embodiment of the present disclosure, when the rollers 52 are fixed to the upper end or lower end of the structure while contacting the left and right tips of the second separator 32 so that the second separator is not folded, the second separator 32 is adsorbed in the left direction and the right direction of the structure to flatten the second separator 32 in the part where the roller will pass.

In one embodiment of the present disclosure, when bonding the second separator 32 in step (3), the second separator is bonded using primary pressurizing members 60 moving in the upper and lower directions at a position spaced apart so that the first separators 31 protruding from the positive electrodes 10 and the negative electrodes 20 to the left and right are not folded.

In one embodiment of the present disclosure, the sides of the pressurizing members are formed obliquely in order for the pressurizing members 60 and the second separator 32 to come into contact in a wider range, when moving the primary pressurizing members 60 in the direction for bonding the second separator 32.

In one embodiment of the present disclosure, when bonding the second separator 32 in step (3), if the positions where the left and right tips of the second separator 32 meet are located on the left side or right side of the structure, the second separator 32 is bonded up and down based on the position where the left and right tips of the second separator 32 meet, and the opposite side is bonded up and down at the position horizontal to the above position.

In one embodiment of the present disclosure, if the left and right tips of the second separator 32 in step (2) are bonded with the upper end or lower end of the structure, the left and right excess portions of the second separator 32 in step (3) are bonded up and down in a horizontal position with the upper end or lower end of the structure to which the second separator 32 is bonded.

In one embodiment of the present disclosure, when bonding the second separator 32 in step (4), the separator is bonded using secondary pressurizing members 70 moving in left and right directions, after folding the separator in the vertical direction so that the second separator 32 bonded in step (3) is in contact with the second separator 32 covering the side of the structure.

According to the second aspect of the present disclosure,
the present disclosure provides an electrode assembly manufactured according to the electrode assembly manufacturing process described above.

### Advantageous Effects

When an electrode assembly is manufactured according to the electrode assembly manufacturing process of the present disclosure, it is possible to solve the process defects such as folding and tearing of the separator, and when wrapping the electrode assembly, it is possible to induce an improvement in the performance of the battery by reducing the thickness of the electrode assembly, while preventing deterioration of battery performance that may occur, by using a separator whose length is extended in the left and right directions and using tape for bonding by performing finishing treatment by heat or pressing.

In addition, the electrode assembly manufacturing process of the present disclosure enables wrapping to suit the size of the structure, thereby increasing the utilization value of the electrode assembly, while, above all, minimizing the influence on the initial structure formed by repeatedly stacking the positive electrodes, the separators and the negative electrodes.

### DESCRIPTION OF DRAWINGS

FIGS. 1A and 1B are views showing an exemplary laminate structure applied to the electrode assembly manufacturing process of the present disclosure. The laminate structure of FIG. 1B has a structure in which portions of separators protruding left and right from the positive electrodes and the negative electrodes, as compared with the laminate structure of FIG. 1A.

FIGS. 2A and 2B are views showing an exemplary electrode assembly manufactured according to the electrode assembly manufacturing process of the present disclosure.

FIGS. 3A, 3B, 3C, 3D, and 3E are views sequentially illustrating an exemplary electrode assembly manufacturing process of the present disclosure using the laminate structure of FIG. 1A.

FIGS. 4A, 4B, 4C and 4D are views sequentially illustrating an exemplary electrode assembly manufacturing process of the present disclosure using the laminate structure of FIG. 1B.

### BEST MODE

The terms and words used in the present specification and claims should not be construed as limited to ordinary or dictionary terms, and should be construed in a sense and concept consistent with the technical idea of the present invention, based on the principle that the inventor can properly define the concept of a term to describe his invention in the best way possible. Therefore, since the configuration shown in the embodiments and drawings described in the present specification is only one of the most preferred embodiments of the present invention, and does not represent all of the technical spirit of the present invention, it should be understood that various equivalents and modifications may be substituted for them at the time of filing the present application.

In the drawings, the size of each component or a specific part constituting the component is exaggerated, omitted, or schematically illustrated for convenience and clarity of description. Therefore, the size of each component does not fully reflect the actual size. If it is determined that a detailed description of a related known function or configuration may unnecessarily obscure the gist of the present invention, such description will be omitted.

The present disclosure relates to an electrode assembly manufacturing process, wherein the manufacturing process comprises the steps of introducing a second separator, whose length is extended in the left and right directions, into a structure formed by repeatedly stacking positive electrodes, first separators and negative electrodes to wrap the structure; simultaneously pressing the upper end and the lower end of the structure comprising the introduced second separator to strengthen the adhesive strength between the separator and the electrode; bonding the left and right excess portions of the second separator surrounding the structure up and down, thereby adjusting to meet the standard requirements of the structure; and fixing the bonded second separator by bonding left and right. In this specification, to help understand the electrode assembly manufacturing process according to the present disclosure, drawings are provided, and in this specification, directions of up down left right are referred to from the drawings.

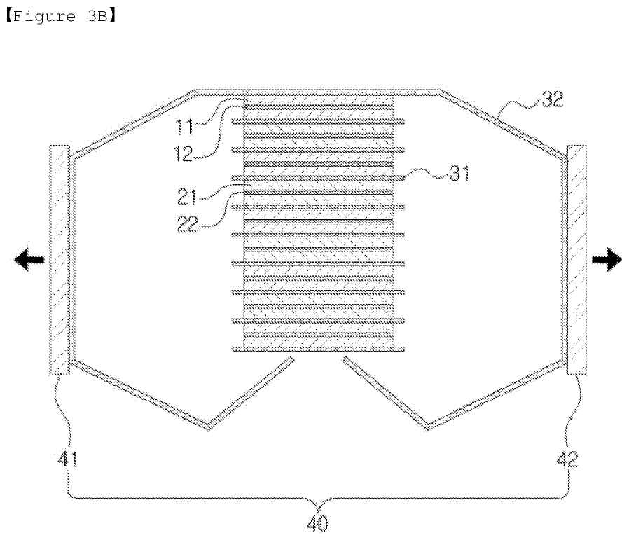

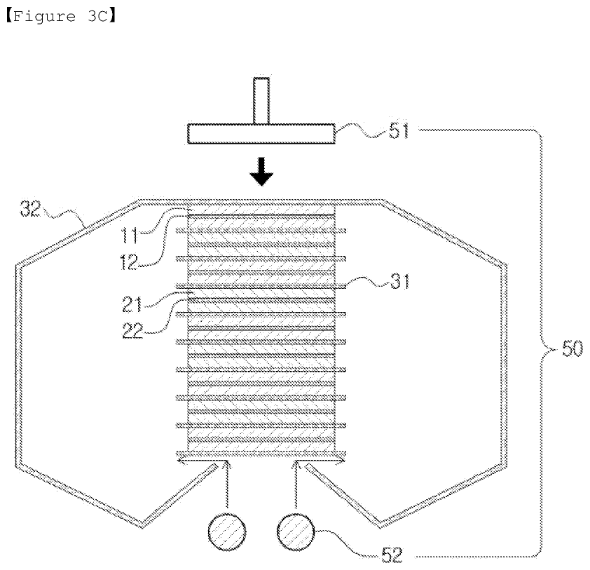

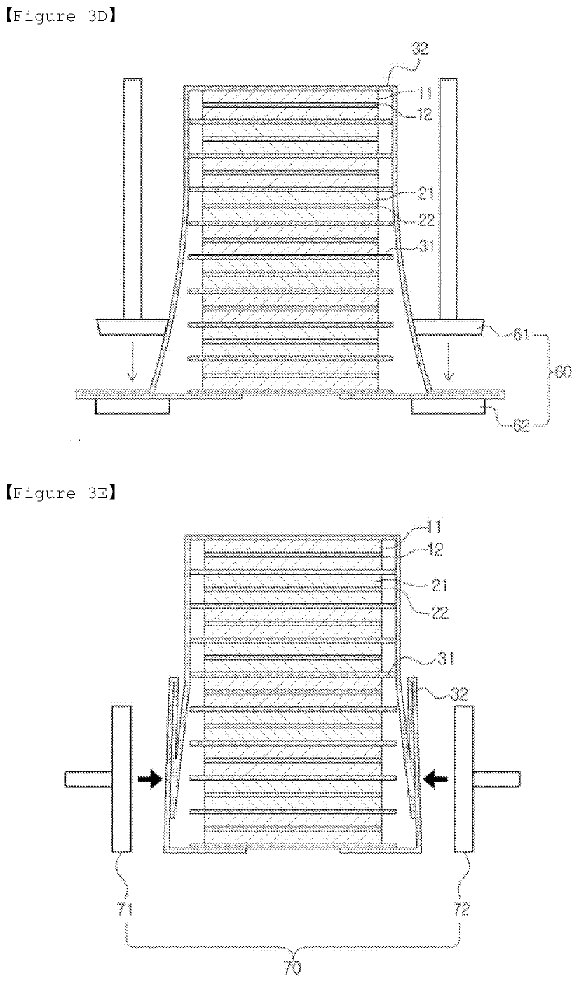

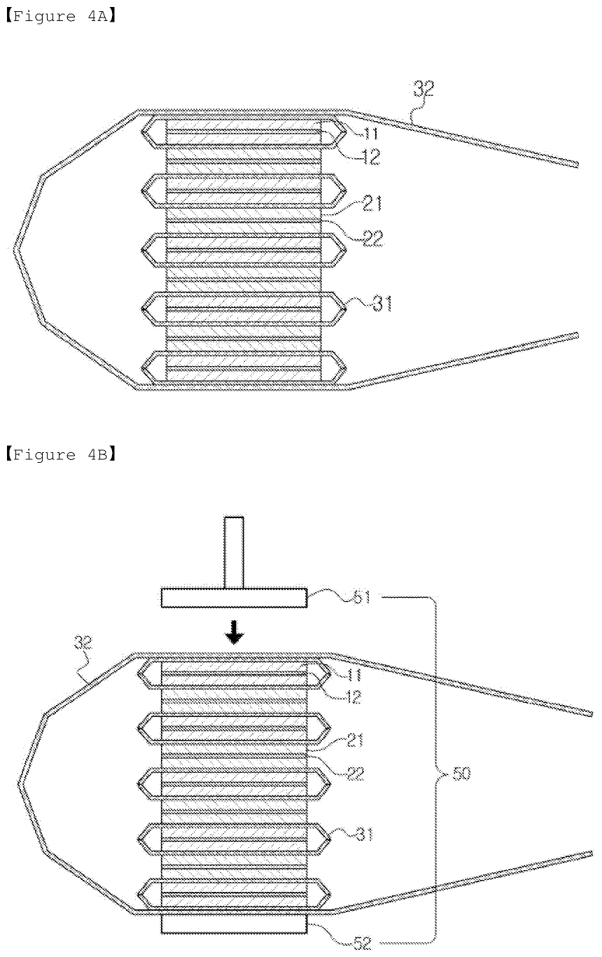

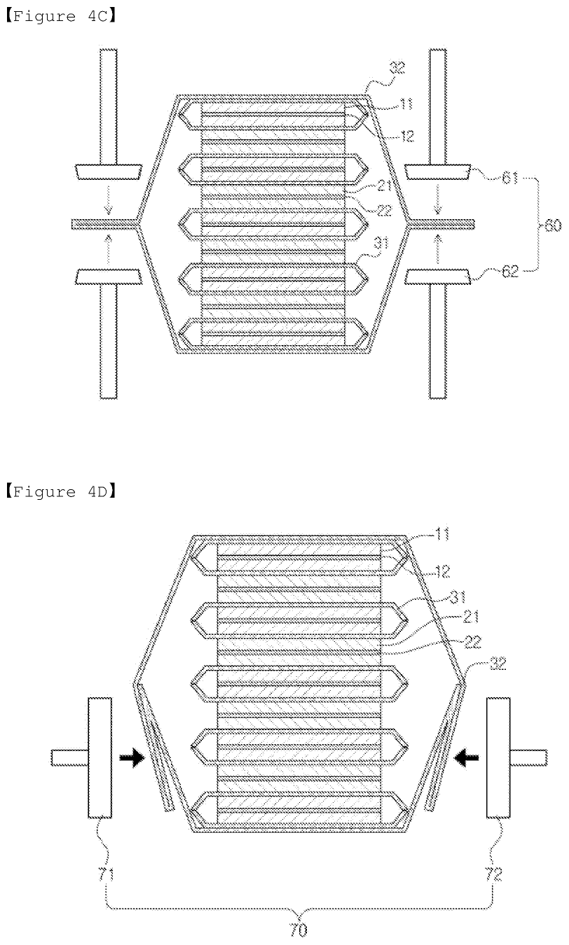

First, the electrode assembly manufacturing process according to the present disclosure comprises the step of introducing the second separator 32, whose length is extended in the left and right directions, into a structure formed by repeatedly stacking the positive electrodes 10, the first separators 31 and the negative electrodes 20 to wrap the structure. The step refers to, but is not limited to, FIGS. 3A, 3B, 4A and 4B herein. In the present specification, separators 30 are described as being divided into the first separator 31 and the second separator 32 according to the function, and the first separator 31 is a component of a laminate structure, and the second separator 32 is a component of an electrode assembly introduced to wrap the laminate structure.

The first separator 31 and the second separator 32 can also be distinguished by size, and the second separator 32 should have a size sufficient to basically wrap the laminate structure in the circumferential direction. In the electrode assembly manufacturing process according to the present disclosure, since the second separator 32 primarily wraps the laminate structure while having a sufficient length of excess portions, and then, the excess portions of the second separator 32 are bonded up and down, thereby secondary adjusting the second separator 32 to the standard requirements of the structure, the second separator 32 may be longer than the length in the circumferential direction of the laminate structure with more than a certain level. According to one embodiment of the present disclosure, the length of the second separator 32 may be 1.5 times to 2.5 times, specifically 1.5 times to 2.3 times, more specifically 1.8 times to 2.3 times longer than the length in the circumferential direction of the laminate structure. Here, the length in the circumferential direction of the laminate structure means the minimum length, at which the second separator 32 surrounds the laminate structure and the left and right tips of the second separator 32 contact each other without changing the shape of the first separators 31 protruding left and right from the positive electrodes 10 and the negative electrodes 20, when wrapping the laminate structure with the second separator 32 having lengths extending in the left and right directions at the upper end or lower end of the structure. If the length of the second separator 32 is shorter than 1.5 times, it is not possible to secure a sufficient length to bond the left and right excess portions of the second separator 32 up and down. If the length of the second separator 32 is longer than 2.5 times, the left and right excess portions of the second separator 32 remain excessively large, so that it is difficult to effectively organize the parts bonded up and down by the second separator 32.

Since the first separator 31 and the second separator 32 use the same material, they are not distinguished in terms of material. The material of the first separator 31 and the second separator 32 may be used without limitation as long as it is a material for a separator for a secondary battery and is generally used in the relevant technical field, and for example, polyolefin-based polymers such as polyethylene and polypropylene may be used.

The second separator 32 is introduced into at least one of the upper end and the lower end of the structure to surround the structure. The second separator 32 may be divided into two, and may be introduced into each of the upper end and the lower end, but being introduced as one may increase the processability.

The positive electrodes 10 and the negative electrodes 20 are repeatedly stacked together with the first separators 31 described above to form a structure to be wrapped with the second separator 32, and at this time, the first separator 31 is interposed between the positive electrode 10 and the negative electrode 20. The positive electrode 10 is formed by applying a positive electrode active material 11 on both surfaces of the positive electrode current collector 12, and the negative electrodes 20 is formed by applying a negative electrode active material 21 to both surfaces of the negative electrode current collector 22. The materials of the positive electrode active material 11, the positive electrode current collector 12, the negative electrode active material 21 and the negative electrode current collector 22 are materials for an electrode for a secondary battery and may be used without limitation as long as they are generally used in the art.

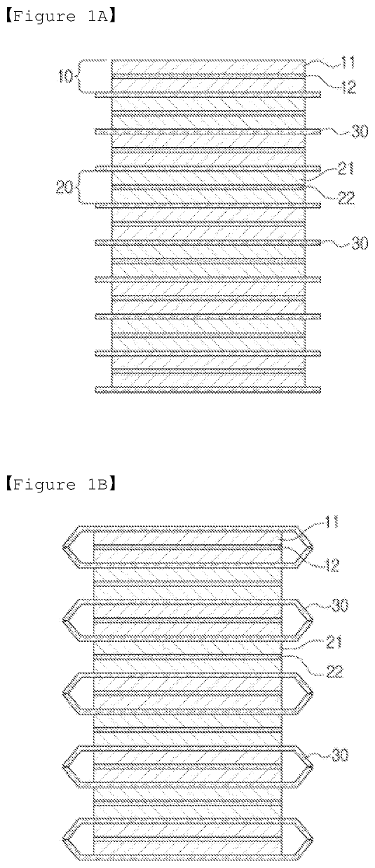

In the laminate structure, in general, the first separators 31 protrude left and right from the positive electrodes 10 and the negative electrodes 20 as shown in FIG. 1A. Due to this shape, the second separator 32 may be in contact with the first separators 31 on the sides of the laminate structure, when wrapping the laminate structure with the second separator 32. If the second separator 32 is wrapped too tightly, the quality of bonding portions between the positive electrodes 10 or the negative electrodes 20 and the first separators 31 may be deteriorated along with damage to the first separators 31. If the portions of the first separators 31 protruding from the positive electrodes 10 and the negative electrodes 20 to the left and right are folded as shown in FIG. 1B, the above-described problem can be solved to some extent, and at this time, if the tips of the folded first separators 31 are brought into contact with one of the neighboring first separators 31, the stability of the structure of the first separators 31 can be improved.

As shown in FIG. 3B, when wrapping the structure with the second separator 32, if the adsorption member 40 is positioned in one or more of the left direction and the right direction of the structure to adsorb the second separator 32 to secure sufficient free space on the sides of the structure, the processability may be increased. The adsorption member 40 uses a vacuum adsorption method to facilitate adsorption and desorption through control of the air pressure, and the air pressure during adsorption is adjusted to the extent that the second separator 32 is not damaged while maintaining the adsorption force with more than a certain level.

After the above-described step, the step of simultaneously pressing the upper end and the lower end of the structure comprising the introduced second separator 32 to strengthen the adhesive strength between the separator and the electrode is performed. As in FIGS. 3C and 4D, the pressurizing is done through the pressurizing members 50 located in the upper and lower directions of the structure, and the pressurizing members 50 press the upper end and the lower end of the structure including the second separator 32 under a pressure condition of 10 to 20 tons, specifically 13 to 20 tons, more specifically 15 to 20 tons per unit area of 150 mm×550 mm. When pressed under the pressure condition, the adhesive strength between each layer of the structure can be improved without collapsing the structure.

As in FIG. 3B, when wrapping the structure with the second separator 32, the left and right tips of the second separator 32 can be positioned to contact the upper end or the lower end of the structure, and in this case, it is necessary to bond the left and right tips of the second separator 32 to the upper end or lower end of the structure and fix them. When bonding the second separator 32 and the structure, the first separator 31 can be positioned in the structure in contact with the second separator 32 to increase bonding efficiency. The bonding of the second separator and the structure is performed under a pressure condition of 10 to 20 tons, specifically 13 to 20 tons, more specifically 15 to 20 tons, per unit area of 150 mm×550 mm, and a temperature condition of 70° C. to 100° C., specifically 75° C. to 100° C., and more specifically 80° C. to 100° C. In order to meet the temperature condition, a heated pressurizing member 50 may be used. If the pressurization is performed with the member heated under the temperature condition, it is possible to effectively bond the second separator with the structure near the member.

When bonding the second separator 32 and the structure, if a flat pressurizing member 51 is used, since the second separator 32 may be folded and a defect may occur, it may be preferable to use a pressurizing member 52 in the form of a roller. The pressurizing members 52 in the form of a roller move in the outside direction from the center of the structure, based on the position where the left and right tips of the second separator 32 are in contact with the upper end or the lower end of the structure as a reference point, and bond the second separator 32 and the structure. At this time, when the pressurizing members 52 in the form of a roller contact the left and right tips of the second separator 32 and are fixed to the upper end or lower end of the structure, if it adsorbs the second separator 32 in the left and right directions of the structure to flatten the second separator 32 in the area where the roller will pass, the second separator 32 can be effectively bonded to the structure without being folded.

After the above-described step, the step of bonding the left and right excess portions of the second separator 32 surrounding the structure, thereby adjusting to meet the standard requirements of the structure is performed. As in FIGS. 3D and 4C, when bonding the second separator 32, the second separator is bonded using the primary pressurizing members 60 moving in the upper and lower directions, in a position spaced apart so that the first separators 31 protruding left and right from the positive electrodes 10 and the negative electrodes 20 are not folded. The bonding of the second separator is performed under a pressure condition of 10 to 20 tons, specifically 13 to 20 tons, more specifically 15 to 20 tons, per unit area of 150 mm×550 mm, and a temperature condition of 70° C. to 100° C., specifically 75° C. to 100° C., and more specifically 80° C. to 100° C. In order to meet the temperature condition, a heated pressurizing member 60 may be used. If the pressurization is performed with the member heated under the temperature condition, it is possible to effectively bond the second separator near the member.

As in the primary upper pressurizing member 61 of FIG. 3D, in the case of the primary pressurizing members 60, the sides of the pressurizing members 60 may be formed obliquely so that the pressurizing members 60 and the second separator 32 can come into contact in a wider range when the pressurizing member moves in the direction of bonding the second separator 32. This shape can reduce the possibility that the second separator 32 is damaged by the primary pressurizing member 60, in particular when the primary pressurizing member 60 passes close to the first separators 31.

As in FIG. 4C, when bonding the second separator 32, when the position where the left and right tips of the second separator 32 meet is located on the left side or right side of the structure, it may be desirable that the second separator 32 is bonded up and down based on the position where the left and right tips of the second separator 32 meet and the opposite side is bonded up and down in a position horizontal to the above position. If it is based on the position where the left and right tips of the second separator 32 do not meet, the second separator can be wasted unnecessarily. If the bonding position of the opposite side is not parallel to the above position, the possibility of damage to the second separator is increased depending on the movement of the primary pressurizing member during the bonding.

As in FIG. 3D, when bonding the second separator 32, if the position where the left and right tips of the second separator 32 meet is located on the left side or right side of the structure, it may be desirable that the second separator 32 is bonded up and down based on the position where the left and right tips of the second separator 32 meet and the opposite side is bonded up and down in a position horizontal to the above position. In this case, since the second separator 32 can be joined by moving only the upper pressurizing member 61 in a state where the position of the lower pressurizing member 62 is fixed, the possibility of damage to the second separator is decreased.

After the above-described step, the step of fixing the bonded second separator 32 by bonding left and right is performed to complete the electrode assembly. As in FIGS. 3E and 4D, the separator is bonded by folding the separator in the vertical direction, so that the second separator 32 bonded in the previous step is in contact with the second separator 32 covering the side of the structure, and then using the secondary pressurizing members 70 moving in the left and right directions. The bonding of the second separator is performed under a pressure condition of 0.1 MPa to 0.5 MPa, specifically 0.2 MPa to 0.5 MPa, and more specifically 0.2 MPa to 0.4 MPa, and a temperature condition of 70° C. to 100° C., specifically 75° C. to 100° C., and more specifically 80° C. to 100° C. In order to meet the temperature condition, a heated pressurizing member 70 may be used. When pressurized under the pressure condition and the temperature condition, the second separator can be effectively bonded without collapsing the structure. If the second separator is bonded to the left and right and fixed, the electrode assembly can be subsequently applied to a battery case or a pouch to show high efficiency. Unlike the previous step, since the bonding in this step does not require a strong bonding as a whole and the bonding has to be performed by moving the secondary pressurizing member in the vertical direction with the first separator, the bonding is performed depending on temperature rather than pressure.

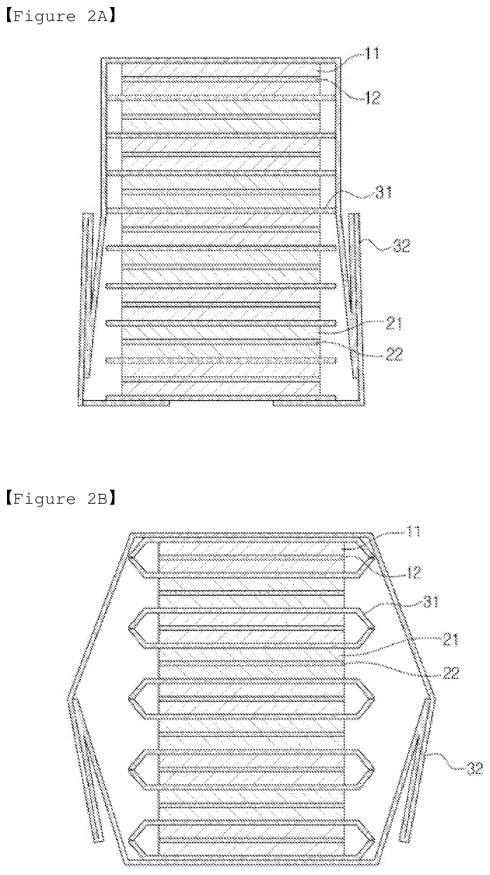

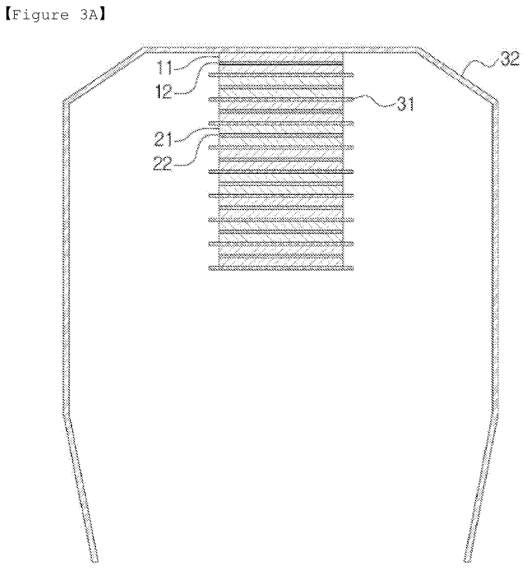

The present disclosure provides an electrode assembly manufactured according to the electrode assembly manufacturing process described above. FIGS. 2A and 2B show exemplary electrode assemblies manufactured according to the electrode assembly manufacturing process of the present disclosure. As shown in FIG. 2B, it may be also possible to secure a space for excess portions between the side of the structure and the second separator according to the user's needs.

In the above, although the present disclosure has been described with reference to limited embodiments and drawings, the present disclosure is not limited thereto, and also it is apparent that various modifications and variations can be made by those of ordinary skill in the art to which the present disclosure pertains within the scope of equivalents of the technical spirit of the present disclosure and the claims to be described below.

### Description of Symbol

10: Positive electrode
11: Positive electrode active material layer
12: Positive electrode current collector
20: Negative electrode
21: Negative electrode active material layer
22: Negative electrode current collector
30: Separator
31: Separator for lamination (first separator)
32: Separator for wrapping (second separator)
40: Adsorption member for separator
41: Left adsorption member for separator
42: Right adsorption member for separator
50: Pressurizing member for electrode assembly
51: Upper pressurizing member for electrode assembly
52: Lower pressurizing member for electrode assembly
60: Primary pressurizing member for separator
61: Primary upper pressurizing member for separator
62: Primary lower pressurizing member for separator
70: Secondary pressurizing member for separator
71: Secondary left pressurizing member for separator
72: Secondary right pressurizing member for separator

1. An electrode assembly manufacturing process comprising the steps of:
(1) wrapping a second separator around a laminate structure stacked along a stacking dimension such that excess portions of the second separator extend outwardly from the laminate structure in a lateral dimension transverse to the stacking dimension, the laminate structure having alternating layers of positive electrodes and negative electrodes stacked along the stacking dimension with a respective first separator portion being interposed between each successive layer of the positive and negative electrodes;
(2) pressing an upper end and a lower end of the laminate structure to strengthen an adhesive strength between the first separator portions and each of the layers of the positive and negative electrodes;
(3) bonding each of the excess portions of the second separator to itself in the stacking dimension so as to define a respective bonded portion of the second separator; and
(4) bonding each of the bonded portions of the second separator to a respective adjacent portion of the second separator in the lateral dimension.

2. The electrode assembly manufacturing process according to claim 1, wherein each of the first separator portions is in contact with an adjacent one of the first separator portions by folding portions of the respective separator portions extending outwardly in the lateral dimension from the laminate structure.

3. The electrode assembly manufacturing process according to claim 1, wherein the length of the second separator is 1.5 to 2.5 times longer than t the circumferential length of the laminate structure.

4. The electrode assembly manufacturing process according to claim 1, wherein when wrapping the laminate structure with the second separator, the second separator is adsorbed against an adsorption member in the lateral dimension in order to secure a space for one of the excess portions of the second separator on a side of the laminate structure.

5. The electrode assembly manufacturing process according to claim 1, wherein when wrapping the structure with the second separator, free ends of the second separator are positioned so as to be in contact with the upper end or lower end of the laminate structure.

6. The electrode assembly manufacturing process according to claim 5, wherein pressing the upper end and lower end of the laminate structure in step (2) includes bonding the free ends of the second separator to the upper or lower end of the laminate structure using a first roller and a second roller moving outwardly from a center of the laminate structure in the lateral dimension.

7. The electrode assembly manufacturing process according to claim 6, wherein the rollers are fixed to the upper end or lower end of the laminate structure while contacting the free ends of the second separator so that the second separator is not folded, and wherein the second separator is adsorbed against an adsorption member in the lateral dimension to flatten the second separator where the rollers will pass.

8. The electrode assembly manufacturing process according to claim 1, wherein when bonding the second separator in step (3), the second separator is bonded using primary pressurizing members spaced apart and moving along the stacking dimension so that the first separators protruding from the laminate structure are not folded.

9. The electrode assembly manufacturing process according to claim 8, wherein sides of the primary pressurizing members are oriented obliquely to increase contact between the pressurizing members and the second separator when bonding the second separator.

10. The electrode assembly manufacturing process according to claim 1, wherein when bonding the second separator in step (3), the free ends of the second separator meet at a position located on the left side or right side of the laminate structure in the lateral dimension, and the step of bonding each of the excess portions of the second separator is performed at the position where the free ends of the second separator meet.

11. The electrode assembly manufacturing process according to claim 6, wherein free ends of the second separator in step (2) are bonded with the upper end or lower end of the laminate structure, and the excess portions of the second separator in step (3) are bonded at respective positions spaced from the free ends in the lateral dimension.

12. The electrode assembly manufacturing process according to claim 1, wherein when bonding the second separator in step (4), the separator is bonded using secondary pressurizing members moving in the lateral dimension after folding the separator in the stacking dimension, such that the adjacent portions of the second separator to which the bonded portions are bonded are portions of the second separator covering the side of the laminate structure extending along the stacking dimension.

13. An electrode assembly manufactured according to the electrode assembly manufacturing process of claim 1.
